(19) United States
(12) Patent Application Publication
(10) Pub. No.: US 2024/0202911 A1
(43) Pub. Date: Jun. 20, 2024

(54) STORAGE MEDIUM STORING COMPUTER PROGRAM, GENERATION APPARATUS, AND GENERATION METHOD

(71) Applicant: BROTHER KOGYO KABUSHIKI KAISHA, Nagoya (JP)

(72) Inventor: Masafumi Miyazawa, Nagoya (JP)

(21) Appl. No.: 18/426,907

(22) Filed: Jan. 30, 2024

Related U.S. Application Data
(63) Continuation of application No. PCT/JP2022/029289, filed on Jul. 29, 2022.

(30) Foreign Application Priority Data
Aug. 6, 2021 (JP) 2021-129595

(51) Int. Cl. G06T 7/00; G06V 30/14; G06V 30/19

(52) U.S. Cl. CPC G06T 7/001; G06V 30/1448; G06V 30/19173; G06T 2207/30144; G06T 2207/30204

(57) ABSTRACT

Based on first captured image data indicating a first captured image of a first inspection target, K object regions corresponding to K (K is an integer larger than or equal to one) objects are detected by using a trained object detection model. The first inspection target includes the K objects and has no abnormality in visual. First correspondence data indicating K correspondences corresponding to respective ones of the K object regions is generated. Each of the K correspondences indicates a correspondence between object region information and condition information. The object region information is information specifying an object region in the first captured image. The condition information indicates an inspection condition associated with a type of the object region, among L (L is an integer larger than or equal to one and smaller than or equal to K) inspection conditions. The first correspondence data is stored in a memory.

### REFERENCE TO RELATED APPLICATIONS

This is a Continuation Application of International Application No. PCT/JP2022/029289 filed on Jul. 29, 2022, which claims priority from Japanese Patent Application No. 2021-129595 filed on Aug. 6, 2021. The entire content of each of the prior applications is incorporated herein by reference.

### BACKGROUND ART

Conventionally, captured images have been used for various kinds of processes.

### DESCRIPTION

For example, there is a proposed technique of recognizing an object for automatic driving using a captured image in front of a vehicle. The captured image may include multiple image regions with different resolutions. An object recognition process is performed based on different determination criteria for image regions with low resolution and for other image regions.

The captured images are used to inspect the visual of various objects, such as label sheets provided on a printer. An inspection target may include one or more objects (for example, strings, marks, and so on). Abnormalities in the visual of each object are checked. Here, the object may be located at various positions within the captured image. Further, suitable conditions for inspection may vary depending on the object. In the inspection, data indicating the correspondence between information (for example, coordinates) specifying the region of the object in the captured image and inspection conditions may be referred to. Such data are generated, for example, by an operator. Generation of such data has been a heavy burden for the operator.

This specification discloses a technique for appropriately generating data for inspection.

According to one aspect, this specification discloses a non-transitory computer-readable storage medium storing a set of program instructions for a computer that generates data for inspecting visual of an inspection target. The set of program instructions, when executed by a controller of the computer, causes the computer to perform, based on first captured image data indicating a first captured image of a first inspection target, detecting K object regions corresponding to K (K is an integer larger than or equal to one) objects by using a trained object detection model. The first inspection target includes the K objects and has no abnormality in visual. Thus, the computer detects K object regions corresponding to K objects. The set of program instructions, when executed by the controller, causes the computer to perform generating first correspondence data indicating K correspondences corresponding to respective ones of the K object regions. Each of the K correspondences indicates a correspondence between object region information and condition information. The object region information is information specifying an object region in the first captured image of the first inspection target. The condition information indicates an inspection condition associated with a type of the object region. The inspection condition is among L (L is an integer larger than or equal to one and smaller than or equal to K) inspection conditions. Thus, the computer generates first correspondence data indicating K correspondences corresponding to respective ones of the K object regions. The set of program instructions, when executed by the controller, causes the computer to perform storing the first correspondence data in a memory. Thus, the first correspondence data is stored in the memory.

According to another aspect, this specification also discloses a generation apparatus. The generation apparatus includes a controller and a memory storing instructions. The instructions, when executed by the controller, cause the generation apparatus to perform, based on first captured image data indicating a first captured image of a first inspection target, detecting K object regions corresponding to K (K is an integer larger than or equal to one) objects by using a trained object detection model. The first inspection target includes the K objects and has no abnormality in visual. Thus, the generation apparatus detects K object regions corresponding to K objects. The instructions, when executed by the controller, cause the generation apparatus to perform generating first correspondence data indicating K correspondences corresponding to respective ones of the K object regions. Each of the K correspondences indicates a correspondence between object region information and condition information. The object region information is information specifying an object region in the first captured image of the first inspection target. The condition information indicates an inspection condition associated with a type of the object region. The inspection condition is among L (L is an integer larger than or equal to one and smaller than or equal to K) inspection conditions. Thus, the generation apparatus generates first correspondence data indicating K correspondences corresponding to respective ones of the K object regions. The instructions, when executed by the controller, cause the generation apparatus to perform storing the first correspondence data in the memory. Thus, the generation apparatus stores the first correspondence data.

According to still another aspect, this specification also discloses a generation method of generating data for inspecting visual of an inspection target. The generation method includes: based on first captured image data indicating a first captured image of a first inspection target, detecting K object regions corresponding to K (K is an integer larger than or equal to one) objects by using a trained object detection model, the first inspection target including the K objects and having no abnormality in visual; generating first correspondence data indicating K correspondences corresponding to respective ones of the K object regions, each of the K correspondences indicating a correspondence between object region information and condition information, the object region information being information specifying an object region in the first captured image of the first inspection target, the condition information indicating an inspection condition associated with a type of the object region, the inspection condition being among L (L is an integer larger than or equal to one and smaller than or equal to K) inspection conditions; and storing the first correspondence data in a memory.

According to the above configuration, the first correspondence data that is usable for determining the inspection condition of the object region during inspection of the first inspection target is appropriately generated.

The technology disclosed in this specification may be implemented in various aspects, and may be embodied in the form of, for example, a method of generating data for inspection, a generation apparatus, an inspection method and an inspection apparatus that use data for inspection, a computer program for realizing the functions of those methods or apparatuses, a storage medium storing the computer program (for example, a non-transitory storage medium), and so on.

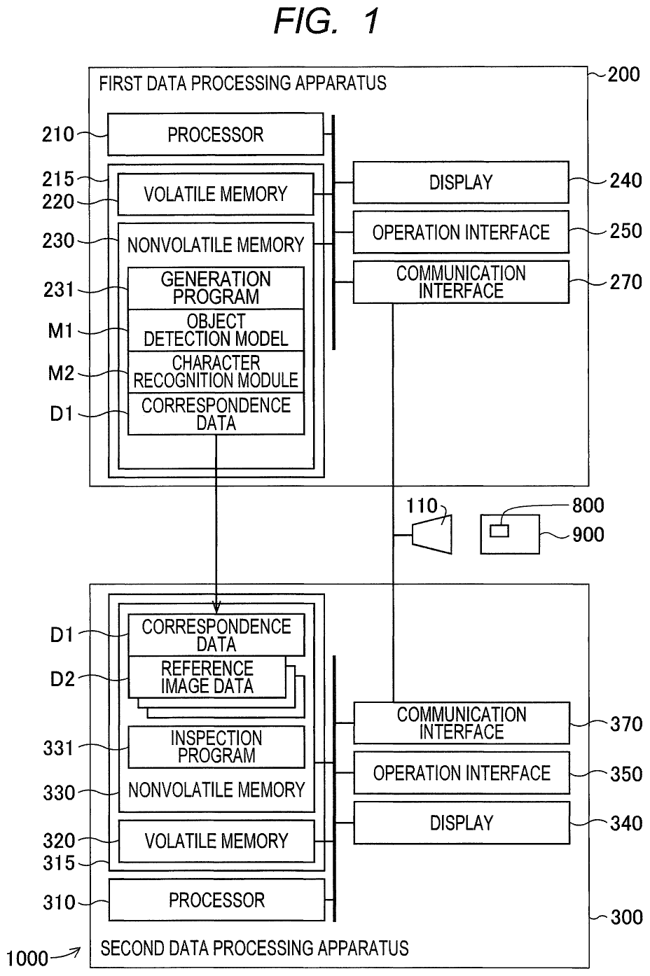

FIG. 1 is an explanatory diagram showing a data processing system.

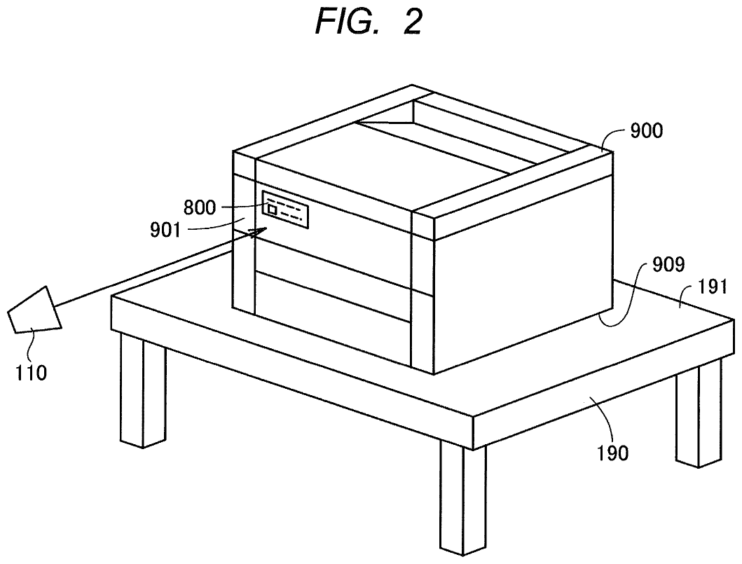

FIG. 2 is a perspective view of a digital camera 110, a multifunction peripheral 900, and a support base 190.

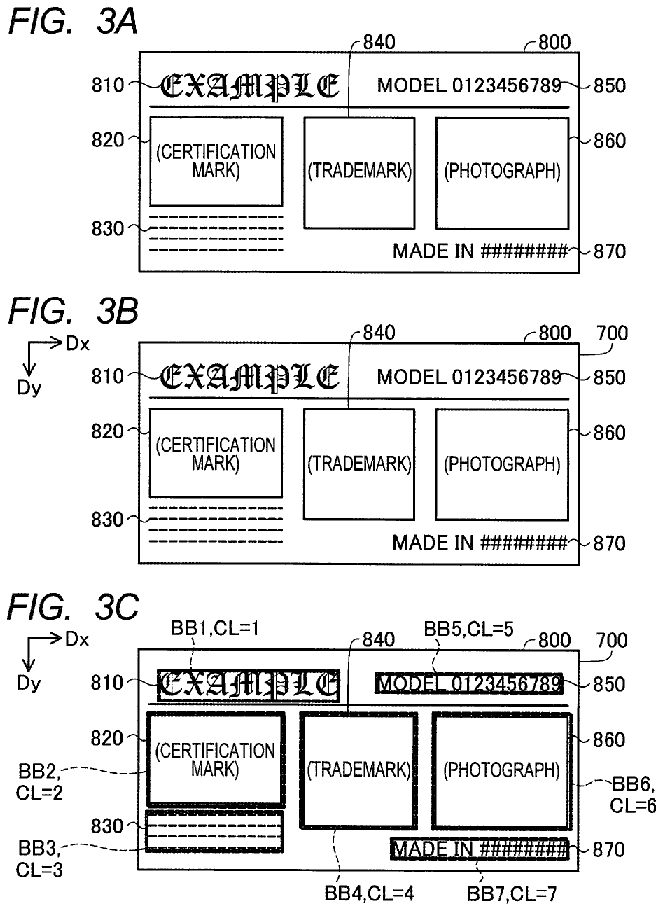

FIG. 3A is a schematic diagram showing an example of a label sheet.

FIG. 3B is a schematic diagram showing an example of a captured image.

FIG. 3C is a schematic diagram showing an example of an object region.

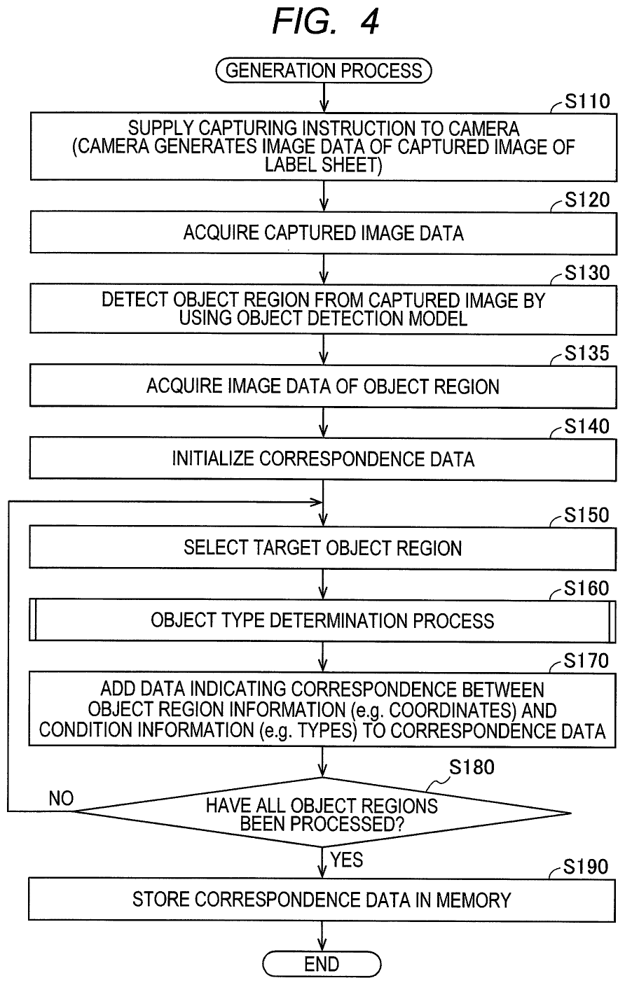

FIG. 4 is a flowchart showing an example of a generation process.

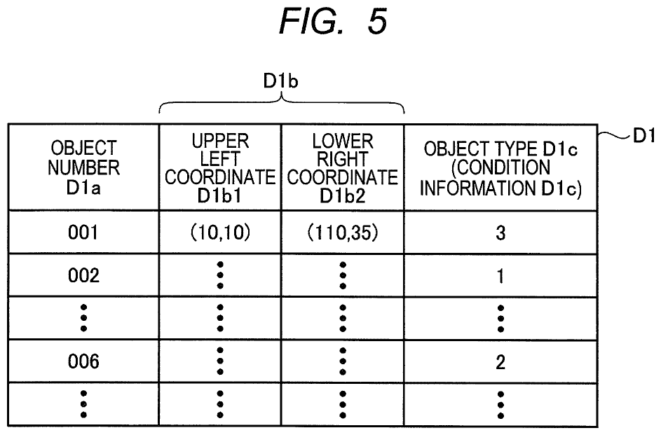

FIG. 5 is a schematic diagram showing an example of correspondence data D1.

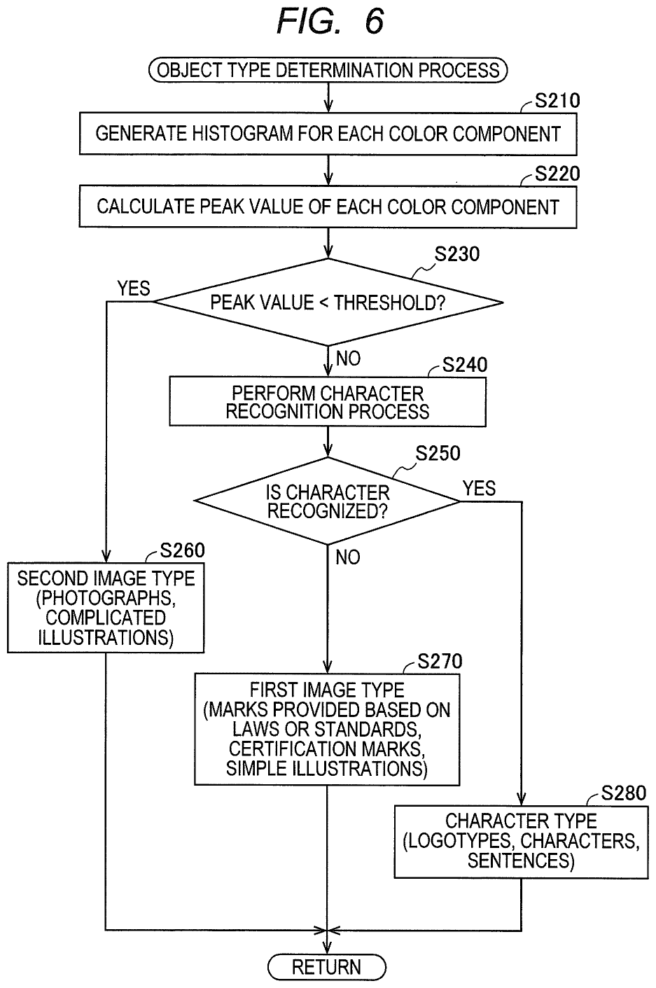

FIG. 6 is a flowchart showing an example of an object type determination process.

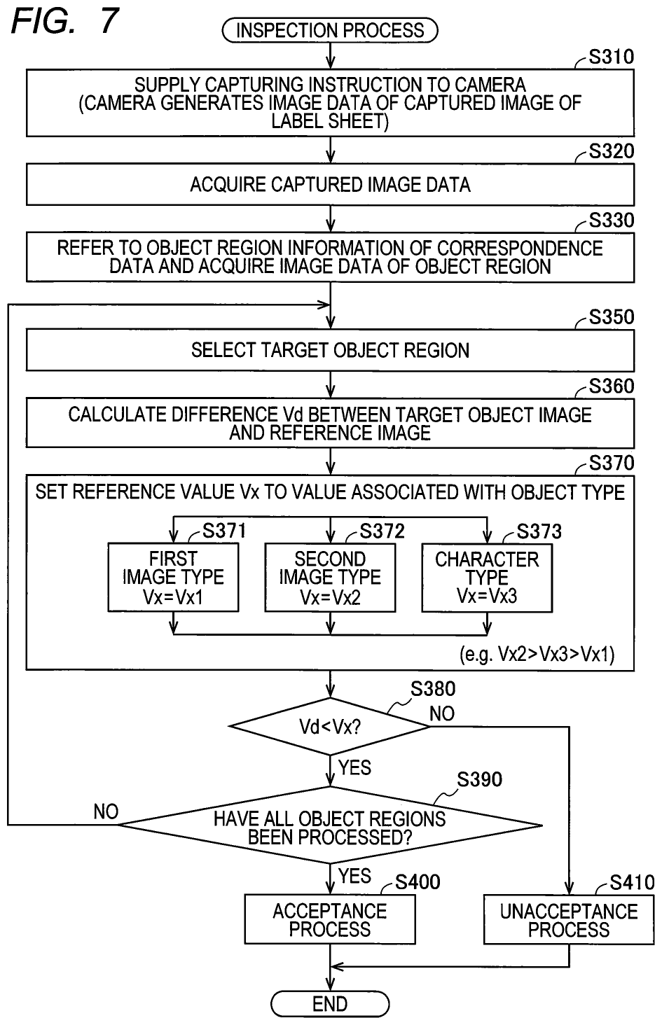

FIG. 7 is a flowchart showing an example of an inspection process.

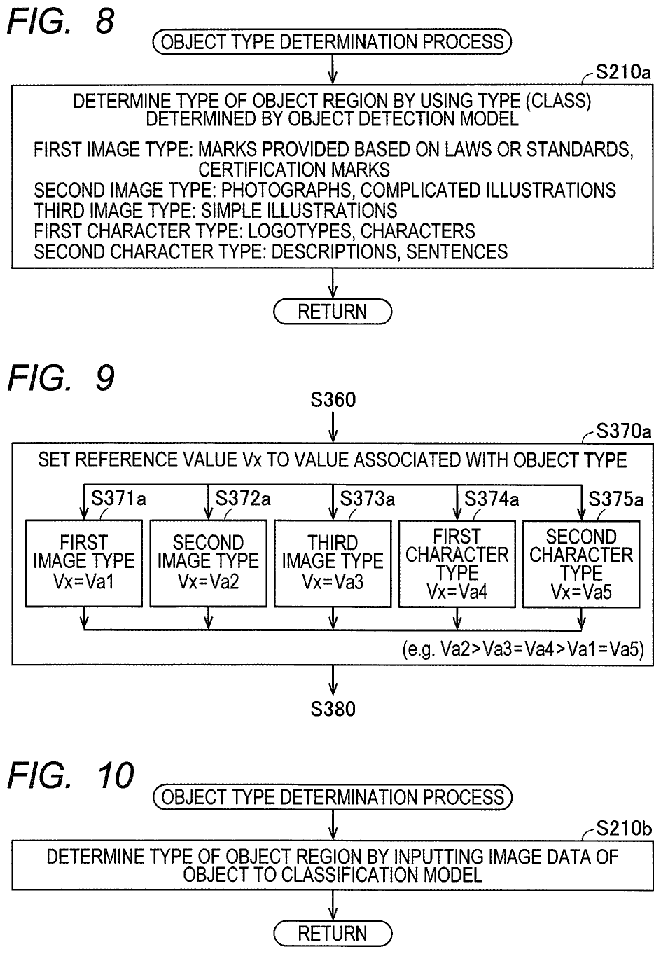

FIG. 8 is a flowchart showing an example of an object type determination process.

FIG. 9 is a flowchart showing an example of an inspection process.

FIG. 10 is a flowchart showing an example of an object type determination process.

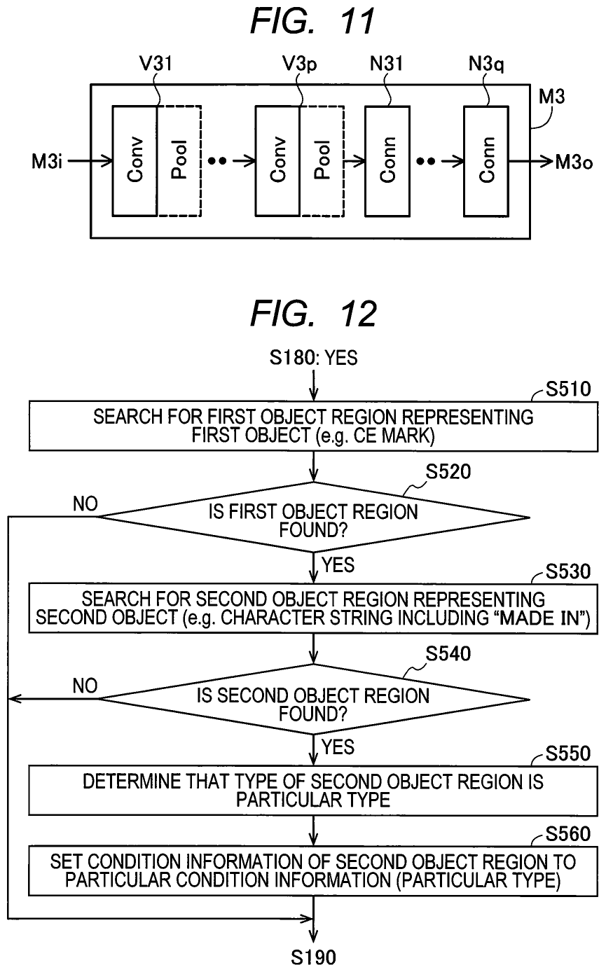

FIG. 11 is a schematic diagram showing an example of a classification model.

FIG. 12 is a flowchart showing an example of a generation process of correspondence data D1.

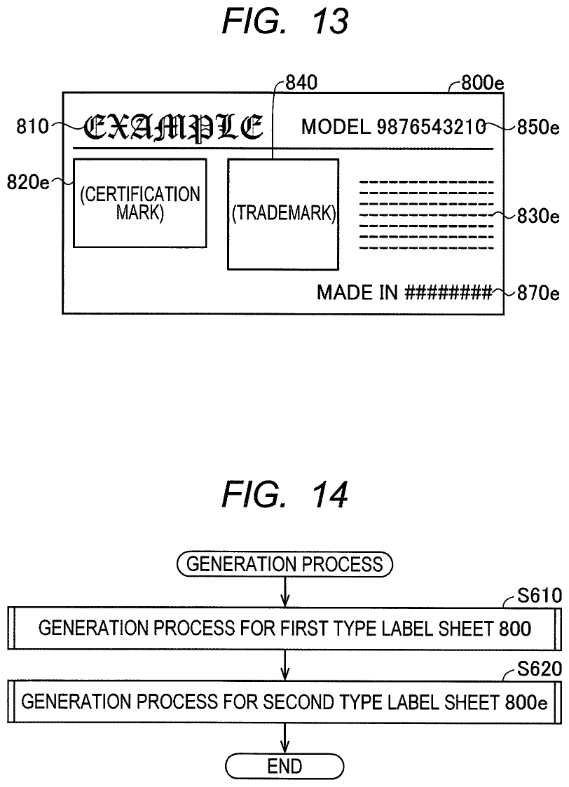

FIG. 13 is a schematic diagram showing an example of a label sheet.

FIG. 14 is a flowchart showing an example of a generation process.

### A. FIRST EMBODIMENT

### A1. Apparatus Configuration:

FIG. 1 is an explanatory diagram showing a data processing system according to an embodiment. In this embodiment, a data processing system 1000 includes a first data processing apparatus 200 and a second data processing apparatus 300. Each of the data processing apparatuses 200 and 300 is, for example, a personal computer. The first data processing apparatus 200 is an example of a generation apparatus that generates data used in inspection of the visual of an inspection target (for example, a label sheet provided on a product such as a multifunction peripheral). The second data processing apparatus 300 is an example of an inspection apparatus that inspects the visual of an inspection target. It is assumed below that the visual of a label sheet 800 provided on a multifunction peripheral (MFP) 900 is inspected.

The first data processing apparatus 200 includes a processor (controller) 210, a memory 215, a display 240, an operation interface 250, and a communication interface 270. These elements are connected to each other via a bus. The memory 215 includes a volatile memory 220 and a nonvolatile memory 230.

The processor 210 is a device configured to perform data processing, such as a CPU. The volatile memory 220 is, for example, a DRAM. The nonvolatile memory 230 is, for example, a flash memory. The nonvolatile memory 230 stores a generation program 231, an object detection model M1, a character recognition module M2, and correspondence data D1. In this embodiment, each of the object detection model M1 and the character recognition module M2 is a program module. The object detection model M1 is a so-called machine learning model. The processor 210 generates the correspondence data D1 according to the generation program 231. Details of the generation program 231, the object detection model M1, the character recognition module M2, and the correspondence data D1 will be described later.

The display 240 is a device configured to display images, such as a liquid crystal display or an organic EL display. The operation interface 250 is a device configured to receive an operation by a user, such as a button, a lever, a touch panel overlaid on the display 240. A user inputs various requests and instructions to the first data processing apparatus 200 by operating the operation interface 250. The communication interface 270 is an interface for communicating with other devices (for example, a USB interface, a wired LAN interface, and an IEEE802.11 wireless interface). A digital camera 110 is connected to the communication interface 270. The digital camera 110 is used for capturing an image of the label sheet 800 of the MFP 900.

The hardware configuration of the second data processing apparatus 300 is the same as that of the first data processing apparatus 200. The second data processing apparatus 300 includes a processor (controller) 310, a memory 315, a volatile memory 320, a nonvolatile memory 330, a display 340, an operation interface 350, and a communication interface 370 corresponding to the elements 210, 215, 220, 230, 240, 250, and 270 of the first data processing apparatus 200, respectively. The digital camera 110 is connected to the communication interface 370. The nonvolatile memory 330 of the second data processing apparatus 300 stores an inspection program 331, the correspondence data D1, and reference image data D2. The correspondence data D1 is generated by the first data processing apparatus 200 and copied from the first data processing apparatus 200 to the second data processing apparatus 300. The reference image data D2 is used in an inspection process described later. Details of the inspection program 331, the correspondence data D1, and the reference image data D2 will be described later.

FIG. 2 is a perspective view of the digital camera 110, the MFP 900, and the support base 190. The support base 190 supports the MFP 900. In this embodiment, the support base 190 has a flat top surface 191. A bottom surface 909 of the MFP 900 is placed on the top surface 191. The label sheet 800 is affixed to a first side surface 901 of the MFP 900. The digital camera 110 is arranged to capture the label sheet 800.

### A2. Label Sheet:

FIG. 3A is a schematic diagram showing an example of a label sheet. FIG. 3A shows the label sheet 800 without defects. In this embodiment, the label sheet 800 represents a logotype 810, a certification mark 820, a description 830, a trademark 840, a first character string 850, a photograph 860, and a second character string 870. Hereinafter, it is assumed that the total number of objects included in the label sheet 800 is K (K=7 in this embodiment). In the figure, illustrations of details of the certification mark 820, the description 830, the trademark 840, and the photograph 860 are omitted. The certification mark 820 is, for example, a mark provided based on standards or laws, such as a CE mark, a GS mark, or an FCC mark. Such marks indicate conformance with standards or laws. Here, conformance to a particular standard may be mandated by law.

Such marks indicating conformance are also a kind of marks provided based on standards or laws. The description 830 describes, for example, notes based on standards or laws. The trademark 840 represents, for example, a mark indicating the manufacturer of the MFP 900. The first character string 850 represents a model number. The photograph 860 represents, for example, a user who operates the MFP 900. The second character string 870 represents the country of manufacture and includes the character string “MADE IN”. In this way, the label sheet 800 contains various types of objects.

In this embodiment, the label sheet 800 is inspected using a captured image of the label sheet 800 captured by the digital camera 110 (FIG. 1). FIG. 3B is a schematic diagram showing an example of a captured image. The captured image 700 is a rectangular image having two sides parallel to a first direction Dx and two sides parallel to a second direction Dy perpendicular to the first direction Dx. The captured image 700 is represented by color values of a plurality of pixels arranged in a matrix along the first direction Dx and the second direction Dy. In this embodiment, the color value is represented by three component values of R (red), G (green), and B (blue), and each component value is represented by 255 gradations from 0 to 255, for example. The captured image 700 in the figure represents the label sheet 800 without defects.

In the present embodiment, in inspection of the label sheet 800, it is determined whether the visual of each of the objects 810 to 870 is normal. Objects may have various defects, such as missing parts in image, deformations, stains, and so on. In a case where the defects are minor, the object is determined to have a normal visual. As will be explained below, the criteria for determining that the visual of an object is normal may differ depending on the type of object.

Regarding character images representing a relatively small number of characters, such as the logotype 810, the first character string 850, and the second character string 870, in a case where a defect is small, the user reads and obtains correct information from the entire character image. For example, even if some characters are difficult to read, the user reads correct information from the entire character image. Such minor defects may be tolerated.

A character image representing a relatively large number of characters, such as the description 830, may represent important information. In this case, it is desired that the character image clearly represents the correct information. Thus, it is desired that the tolerable defects are small compared to the defects tolerable for character images composed of a relatively small number of characters. For example, it is desired that defects that make some characters difficult to read are not tolerated.

Regarding simple illustrations such as the trademark 840, in a case where the defect is small, the user reads the correct information from the entire image. For example, even if part of the illustration has a defect, the user reads the correct information from the entire illustration. Such minor defects may be tolerated.

Regarding the certification mark 820, it is desired that the label sheet 800 represents the correct mark. It is desired that defects that cause the shape of the mark to deviate from the correct shape are not tolerated.

Defects are less noticeable with images that show complicated shapes and multiple colors, such as the photograph 860 and complicated illustrations. Thus, the tolerance for defects may be greater compared with other types of objects.

Thus, the preferred criteria for inspection may differ depending on the type of object region. The correspondence between object regions and object region types (more generally, inspection criteria) may be determined by the operator. However, in a case where a plurality of objects 810 to 870 are included in the label sheet 800, the burden of determining the correspondence is heavy. In this embodiment, the first data processing apparatus 200 (FIG. 1) generates the correspondence data D1 indicating correspondence by using the captured image data.

### A3. Generation Process:

FIG. 4 is a flowchart showing an example of a generation process. The data processing apparatus 200 (FIG. 1) generates the correspondence data D1 by executing the generation process. FIG. 5 is a schematic diagram showing an example of the correspondence data D1. The correspondence data D1 indicates the correspondence between an object number D1a, object region information D1b, and an object type D1c. The object number D1a is the identification number of each of the plurality of objects 810 to 870 included in the label sheet 800 (FIG. 3A). The object region information D1b is information that specifies an object region, which is a region representing an object in a captured image (for example, the captured image 700 (FIG. 3B)). In this embodiment, the object region is a rectangular region surrounded by two sides parallel to the first direction Dx and two sides parallel to the second direction Dy. The object region information D1b indicates a combination of a coordinate D1b1 of the upper left corner of the rectangle and a coordinate D1b2 of the lower right corner of the rectangle. Each coordinate D1b1 and D1b2 indicates the position of a pixel. The object type D1c indicates the identification number of the type of object region. As will be described later, the object type D1c indicates inspection conditions (the object type D1c is also referred to as condition information D1c).

The operator arranges the MFP 900 and the digital camera 110 as shown in FIG. 2. The label sheet 800 without defects is affixed to the MFP 900. The operator connects the digital camera 110 to the communication interface 270 of the first data processing apparatus 200 (FIG. 1). Then, the operator inputs an instruction to start the generation process by operating the operation interface 250. In response to the instruction, the processor 210 executes the generation process of FIG. 4 according to the generation program 231.

In S110, the processor 210 supplies a capturing instruction to the digital camera 110. The digital camera 110 captures the label sheet 800 and generates image data representing the captured image in accordance with the instruction. In S120, the processor 210 acquires the image data from the digital camera 110. Hereinafter, the image data representing a captured image is referred to as captured image data. In this embodiment, the image size (specifically, the number of pixels in the first direction Dx (FIG. 3B) and the number of pixels in the second direction Dy) of the captured image data used in the generation process and the inspection process described later is determined in advance (referred to as processing image size). The processor 210 performs various image processing such as a trimming process of trimming a portion representing the label sheet 800 and a resolution conversion process on the image data acquired from the digital camera 110, thereby acquiring captured image data of the processed image size representing the label sheet 800. The arrangement of the MFP 900 and the digital camera 110 may be adjusted such that the region of the label sheet 800 is extracted by a trimming process of trimming a predetermined region. Alternatively, the processor 210 may perform a trimming process by detecting a region of the label sheet 800 (for example, pattern matching) and extracting the detected region of the label sheet 800. Hereinafter, it is assumed that the captured image data represents the captured image 700 in FIG. 3B.

In S130, the processor 210 uses a trained object detection model M1 to detect an object region of each of K (K=7 in this example) objects 810 to 870 from the captured image. As the object detection model M1, various object detection models may be adopted. In this embodiment, the object detection model M1 is an object detection model called YOLO (You only look once). The YOLO is disclosed in the paper “Joseph Redmon, Santosh Divvala, Ross Girshick, Ali Farhadi, “You Only Look Once: Unified, Real-Time Object Detection”, Proceedings of the IEEE Conference on Computer Vision and Pattern Recognition (CVPR), 2016, pp. 779-788″, for example.

The YOLO model uses a convolutional neural network to predict a rectangular box containing an object and called a bounding box, a confidence that the box contains an object, and a probability of each type of object in a case where the box contains an object (also called class probability). If the boxed region represents the object to be detected, a high confidence is calculated. If the boxed region does not represent the object to be detected, a small confidence is calculated. A box with a confidence higher than or equal to a threshold is used as a box representing the detected object. A box with a confidence lower than the threshold is treated as a box not representing the detected object. The confidence threshold is predetermined. Alternatively, the confidence threshold may be adjusted based on the results of training the object detection model M1. Among a plurality of types of class probabilities associated with a box, the largest class probability indicates the type of object enclosed by the box. The output data from the object detection model M1 indicates a plurality of combinations of bounding boxes, confidences, and class probabilities based on the image data input to the object detection model M1.

FIG. 3C is a schematic diagram showing an example of object regions detected by the object detection model M1. FIG. 3C shows an example in which the image data of the captured image 700 (FIG. 3B) is input to the object detection model M1. As shown, the object detection model M1 detects bounding boxes BB1 to BB7 surrounding the objects 810 to 870, respectively. In this embodiment, the object detection model M1 is preliminarily trained to detect the region of each of the seven types of objects 810 to 870 included in the label sheet 800.

Class identifiers CL1 to CL7 are associated with the bounding boxes BB1 to BB7, respectively. The first class identifier CL1 indicates the type associated with the largest class probability of the first bounding box BB1. In this example, the first class identifier CL1 indicates the logotype 810. Similarly, the class identifiers CL2 to CL7 of the other bounding boxes BB2 to BB7 indicate the type associated with the largest class probability. In this example, the class identifiers CL2 to CL7 indicate the objects 820 to 870, respectively. Thus, the object detection model M1 detects seven types of the objects 810 to 870.

Image data for a plurality of images including images of the objects 810 to 870 are used to train the object detection model M1. A processor for training (for example, the processor 210) uses the image data to perform calculations of the object detection model M1, thereby generating output data. Then, the processor for training adjusts a plurality of parameters of the object detection model M1 such that the output data becomes closer to the correct data. For example, image data of an image including an image of the object 810 is input to object detection model M1. In this case, the plurality of parameters of the object detection model M1 are adjusted such that the output data indicates a bounding box surrounding the object 810, a large confidence associated with that bounding box, and a class probability associated with that bounding box, the class probability being a large class probability indicating the object 810. For the other objects 820 to 870, the plurality of parameters of the object detection model M1 are similarly adjusted.

Various methods may be used to adjust the parameters. In this embodiment, a plurality of parameters of the object detection model M1 are adjusted such that a loss calculated using a loss function is small. The loss function may be various functions for calculating the evaluation value of the difference between the output data and the correct data associated with the image data input to the object detection model M1. In this example, the loss function disclosed in the YOLO article mentioned above is used. As an algorithm for adjusting a plurality of parameters, for example, an algorithm using backpropagation and gradient descent may be adopted. Here, a so-called Adam's optimization may be performed. The correct data is generated in advance by an operator.

In S130 (FIG. 4), the processor 210 uses the image data of the captured image 700 to perform the calculations of the trained object detection model M1 (FIG. 1), thereby generating output data. The generated output data indicates the bounding boxes BB1 to BB7 described with reference to FIG. 3C.

In S135, the processor 210 acquires, for each of K (K=7 in this embodiment) object regions, object region image data representing an image of the object region from the captured image data. The processor 210 stores the acquired data in the memory 215 (for example, the nonvolatile memory 230).

In S140, the processor 210 initializes correspondence data D1 (FIG. 5). In this embodiment, the processor 210 generates empty correspondence data D1.

In S150, the processor 210 selects, as a target object region, an unprocessed object region from the K object regions detected in S130.

In S160, the processor 210 executes an object type determination process. This process is a process of determining the type of the target object region. FIG. 6 is a flowchart showing an example of the object type determination process.

In S210, the processor 210 generates a histogram for each color component by using the object region image data of the target object region. In this embodiment, three histograms of the RGB color components are generated.

In S220, the processor 210 calculates a peak value of each color component by using the histogram. The peak value is a component value that indicates the highest frequency. Note that a background color range may be excluded from the calculation of the peak value. The background color range may be, for example, the color range corresponding to black (a color range including zero) or the color range corresponding to white (a color range including 255). The background color range may be predetermined. Alternatively, the processor 210 may determine a background color value by analyzing the captured image, and determine a background color range that includes the determined background color value.

In S230, the processor 210 determines whether the peak value is smaller than a peak threshold. The peak value may be different depending on the type of object region. For example, in a case where the target region image represents a large number of colors, such as a photograph or a complicated illustration, each component value is distributed over a wide range from small values to large values. As a result, the peak value can be small. In a case where the target region image represents a small number of colors, such as a simple illustration such as a trademark, a certification mark, or a character string, the peak value of each color component usually indicates the color of the object. The color of an object may be a color represented using large component values, such as red, green, blue, and yellow. In this case, the peak value of one or more color components can be large. In this way, the type of object region is classified by using the peak value.

In this embodiment, the processor 210 determines whether a first condition is satisfied that all peak values of all color components are smaller than the peak threshold. In response to determining that the first condition is satisfied (S230: Yes), in S260 the processor 210 determines that the type of the target object region is a second image type, and ends the processing of FIG. 6. The second image type is a type that includes photographs and complicated illustrations. The peak threshold is experimentally determined in advance so as to classify the second image type, which includes photographs and complicated illustrations, and other types.

In response to determining that the first condition is not satisfied, that is, the peak value of one or more color components is larger than or equal to the peak threshold (S230: No), in S240 the processor 210 performs a character recognition process of the target region image by executing the character recognition module M2. The character recognition process may be various known processes. For example, an optical character recognition engine called “Tesseract OCR” from Google may be used. Alternatively, pattern matching using preliminarily prepared character images may be used.

In S250, the processor 210 determines whether a character is recognized from the target region image in S240. In response to determining that a character is recognized (S250: Yes), in S280 the processor 210 determines that the type of the target object region is a character type, and ends the processing of FIG. 6. The character type is a type of object region representing characters, and is a type including logotypes, sentences, and characters.

In response to determining that no character is recognized in S240 (S250: No), in S270 the processor 210 determines that the type of the target object region is a first image type, and ends the processing of FIG. 6. The first image type is a type including marks provided based on laws or standards (certification marks, legal marks, standard marks, and so on) and simple illustrations such as icon images and trademarks.

As described above, in the object type determination process of FIG. 6, the processor 210 determines the type of the target object region by analyzing the target region image based on the predetermined rule. The processor 210 determines the type of the target object region to be one of three types: the first image type, the second image type, and the character type. After the object type determination process (that is, S160 in FIG. 4), in S170 the processor 210 adds data indicating the correspondence of the target object regions to the correspondence data D1 (FIG. 5). The object numbers D1a are assigned in ascending order from number 1. The object region information D1b indicates the coordinates of the corners of the bounding box indicating the target object region. The object type D1c indicates the type of the object region determined in S160. For example, number 1 indicates the first image type, number 2 indicates the second image type, and number 3 indicates the character type.

In S180, the processor 210 determines whether all object regions have been processed. In response to determining that an unprocessed object region remains (S180: No), the processor 210 returns to S150 to process the unprocessed object region. In response to determining that the processing of all object regions is completed (S180: Yes), in S190 the processor 210 stores the correspondence data D1 in the memory 215 (for example, the nonvolatile memory 230), and ends the processing of FIG. 4. The correspondence data D1 generated by the above generation process indicates the correspondences of all the objects 810 to 870 on the label sheet 800 (FIG. 3A).

### A4. Inspection Process:

FIG. 7 is a flowchart showing an example of the inspection process. The second data processing apparatus 300 (FIG. 1) inspects the label sheet 800 of the MFP 900 (FIG. 2) by executing the inspection process. In the inspection process, the processor 310 (FIG. 1) uses the correspondence data D1 and reference image data D2. The operator copies the correspondence data D1 generated in the processing of FIG. 4 from the nonvolatile memory 230 of the first data processing apparatus 200 to the nonvolatile memory 330 of the second data processing apparatus 300. The reference image data D2 is composed of image data of reference images, which are respective images of the objects 810 to 870 without defects. The configuration of the reference image is the same as the configuration of the object region image specified by the object region information D1b (FIG. 5) of the corresponding object region. For example, the number of pixels in the first direction Dx, the number of pixels in the second direction Dy, and the color components of the color values of each pixel are the same between the reference image and the object region image. The operator generates the reference image data D2 in advance by using the captured image data of the label sheet 800 without defects. Alternatively, the processor 210 of the first data processing apparatus 200 may generate the reference image data D2 by using the object region image data of each object region acquired in S135 of FIG. 4.

As shown in FIG. 2, the operator arranges the MFP 900 to be inspected and the digital camera 110. The label sheet 800 of the MFP 900 may have defects. The operator connects the digital camera 110 to the communication interface 370 of the second data processing apparatus 300 (FIG. 1). Then, the operator operates the operation interface 350 to input an instruction to start the inspection process. In response to the instruction, the processor 310 executes the inspection process according to the inspection program 331.

S310 and S320 are the same as S110 and S120 in FIG. 4, respectively. The processor 310 acquires captured image data of the label sheet 800 by using the image data from the digital camera 110.

In S330, the processor 310 refers to the object region information D1b of the correspondence data D1 (FIG. 5). The processor 310 acquires the object region image data representing an image of the object region from the captured image data, for each of the K object regions specified by the correspondence data D1.

In S350, the processor 310 selects, as a target object region, an unprocessed object region from the K object regions.

In S360, the processor 310 calculates a difference Vd between the image of the target object region (referred to as target object image) and the reference image corresponding to the target object region. The reference image is an image represented by the reference image data D2, and is an image of the object without defects. The difference Vd may be various values indicating the difference between the target object image and the reference image. In this embodiment, the processor 310 calculates the difference Vd as follows. The processor 310 calculates, for each pixel, three absolute values of the three differences of the three RGB component values between the target object image and the reference image. The processor 310 calculates, for each pixel, a total difference value which is the total value of the three absolute values of the three differences. The processor 310 calculates, as the difference Vd, the average value of the total difference values of all pixels in the target object region. The difference Vd calculated in this way increases as the difference between the target object image and the reference image increases. Instead of the above values, the difference Vd may be various values indicating the difference between the target object image and the reference image, such as an L2 norm using each difference of RGB.

In S370, the processor 310 refers to the correspondence data D1 and acquires the object type D1c of the target object region. Then, the processor 310 sets a reference value Vx indicating the condition for inspection to a value that is associated in advance with the object type D1c (S371, S372, S373). The correspondence between the object type D1c and the reference value Vx is as follows.
First image type: Vx=Vx1
Second image type: Vx=Vx2
Character type: Vx=Vx3

These values Vx1, Vx2, and Vx3 are determined experimentally in advance such that the difference Vd is larger than or equal to the reference value Vx when the image of the object in the target object region has a defect which should not be tolerated. In this embodiment, Vx2>Vx3>Vx1. The first reference value Vx1 for the first image type including certification marks allows a relatively small difference Vd, and the second reference value Vx2 for the second image type including photographs allows a relatively large difference Vd. The third value Vx3 for the character type is a value between the values Vx1 and Vx2.

In S380, the processor 310 determines whether the difference Vd is smaller than the reference value Vx. In response to determining that the difference Vd is larger than or equal to the reference value Vx (S380: No), the inspection result is unacceptable (failure). In this case, in S410, the processor 310 displays information indicating the unacceptable inspection result on the display 340. The processor 310 then ends the processing of FIG. 7.

In response to determining that the difference Vd is smaller than the reference value Vx (S380: Yes), the inspection result is acceptable (pass). In this case, in S390, the processor 310 determines whether all object regions have been processed. If an unprocessed object region remains (S390: No), the processor 310 returns to S350 to process the unprocessed object region. In response to determining that the inspection results of all object regions are acceptable (S390: Yes), in S400 the processor 310 displays information indicating the acceptable inspection result on the display 340. The processor 310 then ends the processing of FIG. 7.

The processing of S400 and S410 may be any processing associated with the inspection result. For example, the processor 310 may store inspection result data indicative of the inspection result in the memory 315 (for example, the nonvolatile memory 330). In this way, the processor 310 may perform an output process of outputting the inspection result data to a memory or a display.

As described above, in the generation process of FIG. 4 in this embodiment, the processor 210 of the first data processing apparatus 200 (FIG. 1) generates the correspondence data D1 for inspecting the visual of the label sheet 800 which is an example of an inspection target. In S130, the processor 210 detects the K object regions corresponding to the K objects 810 to 870 (the regions surrounded by the bounding boxes BB1 to BB7 in this embodiment) from the captured image data representing the captured image of the label sheet 800 containing K (in this embodiment, K=7) objects and having no abnormality in visual, by using the trained object detection model M1. In S135 to S180, the processor 210 generates the correspondence data D1 (FIG. 5) indicating K correspondences respectively corresponding to the K object regions. As shown in FIG. 5, each of the K correspondences indicates the correspondence between the object region information D1b and the object type D1c (that is, the condition information D1c). The object region information D1b (the coordinates D1b1 and D1b2 in this embodiment) is an example of information that specifies the object region in the captured image of the label sheet 800. As described in S370 of FIG. 7, the condition information D1c indicates the inspection condition associated with the type of the object region among L (in this embodiment, L=3) inspection conditions (specifically, the reference values Vx1, Vx2, and Vx3). Thus, the object type D1c is an example of condition information indicating inspection condition. In S190 of FIG. 4, the processor 210 stores the correspondence data D1 in the memory 215.

According to this configuration, when inspecting the label sheet 800 (FIG. 7), the correspondence data D1 used for determining the inspection condition of the object region (here, the reference value Vx) is appropriately generated. If an operator determines information indicating the coordinates and type of each object region and inputs the determined information into the first data processing apparatus 200, the burden on the operator is heavy. In particular, in a case where the label sheet 800 includes a plurality of objects as in the embodiment of FIG. 3A, it is not easy for the operator to determine the correct correspondence of each of the plurality of objects. In this embodiment, the processor 210 generates appropriate correspondence data D1, and the operator need not determine the coordinates and type of the object region. Thus, the burden on the operator is greatly reduced.

Further, as described with reference to FIG. 6, in the process of generating the correspondence data D1, the processor 210 determines the type of the object region (here, the object type D1c) by analyzing the image of the object region based on a predetermined rule. The processor 210 generates appropriate correspondence data D1 based on the predetermined rule.

In this embodiment, as described with reference to FIG. 7, the reference value Vx indicating the inspection condition is set to one of the three values Vx1, Vx2, and Vx3 depending on the type of object region. That is, the total number L of inspection conditions is three, which is a value of two or more. In S360 of FIG. 7, the processor 310 calculates the difference Vd. The difference Vd indicates the difference between the target object image which is the image of the region indicated by the object region information D1b (FIG. 5) in the captured image for inspection, and the reference object image which is the image of the object with no abnormality and preliminarily associated with the object region information D1b. As described in S380 of FIG. 7, the L inspection conditions (that is, the L reference values Vx1, Vx2, and Vx3) are conditions for determining that the difference Vd indicates that the visual of the object represented by the target object image is normal. Here, a relatively large first reference value Vx1 allows a relatively large difference Vd, and a relatively small second reference value Vx2 allows a relatively small difference Vd. The third reference value Vx3 is a value between the values Vx1 and Vx2. In this way, the L inspection conditions include a plurality of inspection conditions indicating different criteria (in this embodiment, different reference values Vx1, Vx2, and Vx3) for determining that the difference Vd indicates that the visual is normal. Thus, in this embodiment, each object region is inspected according to appropriate inspection condition associated with the type of object region, which enables the label sheet 800 to be inspected appropriately. In the generation process of FIG. 4, the processor 210 appropriately generates the correspondence data D1 which is referred to in such inspection.

As shown in FIG. 6, the type of object region is one of L types including the first image type including marks provided based on standards or laws. As described in S370 of FIG. 7, the first reference value Vx1 associated with the first image type is the smallest among the L reference values Vx1, Vx2, and Vx3 associated with the L types. That is, the criterion indicated by the inspection condition associated with the first image type (here, the first reference value Vx1) is the criterion that is most difficult to satisfy among the L criteria indicated by the L inspection conditions associated with the L types (here, the reference values Vx1, Vx2, and Vx3). This reduces the possibility of erroneously determining that the difference Vd of the mark does not indicate an abnormality in visual in a case where the mark provided based on the standard or law has a defect.

As shown in FIG. 6, the type of object region is one of L types including the second image type including photographs. As described in S370 of FIG. 7, the second reference value Vx2 associated with the second image type is the largest among the L reference values Vx1, Vx2, and Vx3 associated with the L types. That is, the criterion indicated by the inspection condition associated with the second image type (here, the second reference value Vx2) is the criterion that is most easily satisfied among the L criteria indicated by the L inspection conditions associated with the L types (here, the reference values Vx1, Vx2, and Vx3). This reduces the possibility of determining that the difference Vd in the photograph indicates an abnormality in visual in a case where a defect in a photograph is a small defect that should be tolerated.

The type of the object region is one of L types including the character type including characters and the second image type including photographs. As described in S370 of FIG. 7, the third reference value Vx3 associated with the character type is smaller than the second reference value Vx2 associated with the second image type. That is, the criterion indicated by the inspection condition associated with the character type (here, the third reference value Vx3) is more difficult to satisfy than the criterion indicated by the inspection condition associated with the second image type (here, the second reference value Vx2). This reduces the possibility of erroneously determining that the difference Vd of the character having a defect does not indicate an abnormality in visual. This also reduces the possibility of determining that that the difference Vd of the photograph indicates an abnormality in visual in a case where the defect in the photograph is a small defect that should be tolerated.

### B. SECOND EMBODIMENT

FIG. 8 is a flowchart showing another embodiment of the object type determination process. In S160 of FIG. 4, the processor 210 of the first data processing apparatus 200 (FIG. 1) executes the processing of FIG. 8 instead of the processing of FIG. 6. In this embodiment, the processor 210 uses the object region type determined by the object detection model M1 in S130 of FIG. 4 to determine the object region type associated with the inspection condition (that is, the object type D1c (FIG. 5)). In the example of FIG. 8, the processor 210 determines the object type D1c to be one of the following five types.
First image type: a type that includes marks provided based on laws or standards
Second image type: a type that includes photographs and complicated illustrations
Third image type: a type that includes simple illustrations
First character type: a type that includes a character image that consists of a relatively small number of characters, such as logotypes
Second character type: a type that includes a character image that consists of a relatively large number of characters, such as descriptions

The correspondence between the type determined by the object detection model M1 and the object type D1c is determined in advance, which is as follows in this embodiment.
Logotype 810: first character type
Certification mark 820: first image type
Description 830: second character type
Trademark 840: third image type
First character string 850: first character type
Photograph 860: second image type
Second Character string 870: first character type

In S210a, the processor 210 determines the object type D1c according to the above correspondence. The processor 210 then ends the processing of FIG. 8.

FIG. 9 is a flowchart showing another embodiment of the inspection process. The difference from the embodiment of FIG. 7 is that S370 of FIG. 7 is replaced with S370a of FIG. 9. The processing of other portions of the inspection process is the same as the processing of the corresponding portions in FIG. 7 (illustration and description of the same portions are omitted).

In S370a, the processor 310 of the second data processing apparatus 300 (FIG. 1) refers to the correspondence data D1 and acquires the object type D1c of the target object region. Then, the processor 310 sets the reference value Vx indicating the condition for inspection to the value associated in advance with the object type D1c (S371a to S375a). The correspondence between the object type D1c and the reference value Vx is as follows.
First image type: Vx=Va1
Second image type: Vx=Va2
Third image type: Vx=Va3
First character type: Vx=Va4
Second character type: Vx=Va5

These values Va1 to Va5 are experimentally determined in advance such that the difference Vd is larger than or equal to the reference value Vx when the image of the object in the target object region has a defect that should not be tolerated. In this embodiment, Va2>Va3=Va4>Va1=Va5. The first reference value Va1 for the first image type including the certification mark and the fifth reference value Va5 for the second character type including the description have the minimum value among the five reference values, and allows a relatively small difference Vd. The second reference value Va2 for the second image type including photographs has the maximum value among the five reference values, and allows a relatively large difference Vd. The third reference value Va3 for the third image type including the trademark and the fourth reference value Va4 for the first character type including the logotype have a value between the above-mentioned minimum and maximum values.

As described above, the generation process of this embodiment is the same as the generation process of the first embodiment (FIG. 4) except for the following two points.
(1) The type determined by the object detection model M1 is used to determine the object type D1c.
(2) The number of types of the object type D1c is five.

Thus, this embodiment has the same various advantages as the first embodiment. For example, the processor 210 generates appropriate correspondence data D1, and the operator need not determine the coordinates and types of the object regions.

As described with reference to FIG. 8, in the process of generating the correspondence data D1, the processor 210 determine the type of object region (here, the object type D1c) by using the trained object detection model M1 (FIG. 4: S130). The processor 210 generates appropriate correspondence data D1 by using the detection results by the object detection model M1.

In this embodiment, as described with reference to FIG. 9, the reference value Vx indicating the inspection condition is set to one of the five values Va1 to Va5 depending on the type of the object region. That is, the total number L of inspection conditions is five, which is a value of two or more. The L inspection conditions include a plurality of inspection conditions that indicate different criteria for determining that the difference Vd indicates that the visual is normal. In this embodiment, the criteria are different among the following three reference value groups.
(First group) Va2
(Second group) Va3, Va4
(Third group) Va1, Va5

As described above, in this embodiment, each object region is inspected according to the appropriate inspection condition associated with the object region type, which enables appropriate inspection of the label sheet 800. In the generation process of FIGS. 4 and 8, the processor 210 appropriately generates the correspondence data D1 which is referred to in such inspection.

As shown in FIG. 8, the type of object region is one of L types including the first image type including marks provided based on standards or laws. As described in S370a of FIG. 9, the first reference value Va1 associated with the first image type is the smallest among the L reference values Va1 to Va5. That is, the first reference value Va1 associated with the first image type is the reference value that is most difficult to satisfy among the L reference values Va1 to Va5 associated with the L types. This reduces the possibility of erroneously determining that the difference Vd of the mark does not indicate an abnormality in visual in a case where a mark provided based on laws or standards has a defect. In this embodiment, the fifth reference value Va5 for the second character type including description is the same as the first reference value Va1. This reduces the possibility of erroneously determining that the difference Vd in the description does not indicate an abnormality in visual in a case where a description has a defect. In this way, the plurality of reference values Va1 and Va5 corresponding to the plurality of types may be the smallest reference value (that is, the reference value that is most difficult to satisfy).

As shown in FIG. 8, the type of object region is one of L types including the second image type including photographs. As described in S370a of FIG. 9, the second reference value Va2 associated with the second image type is the largest among the L reference values Va1 to Va5. That is, the second reference value Va2 associated with the second image type is the reference value that is easiest to satisfy among the L reference values Va1 to Va5. This reduces the possibility of determining that the difference Vd in a photograph indicates an abnormality in visual in a case where the defect in the photograph is a small defect that should be tolerated.

As shown in FIG. 8, the type of the object region is one of L types including the first and second character types including characters, and the second and third image types including illustrations and/or photographs. As described in S370a of FIG. 9, the reference values Va4 and Va5 associated with the first and second character types are smaller than each of the reference values Va2 and Va3 associated with the second and third image types. That is, the reference values Va4 and Va5 associated with the first and second character types are more difficult to satisfy than each of the reference values Va2 and Va3 associated with the second and third image types. This reduces the possibility of erroneously determining that the difference Vd of characters having a defect does not indicate an abnormality in visual. And, this reduces the possibility of determining that the difference Vd between illustrations with small tolerable defects or the difference Vd between photographs with small tolerable defects indicates an abnormality in visual.

### C. THIRD EMBODIMENT

FIG. 10 is a flowchart showing another embodiment of the object type determination process. In S160 of FIG. 4, the processor 210 of the first data processing apparatus 200 (FIG. 1) executes the processing of FIG. 10 instead of the processing of FIG. 6. In this embodiment, the processor 210 determines the type of object region (that is, the object type D1c (FIG. 5)) associated with the inspection condition by inputting image data of the target object region to a trained classification model. In this embodiment, the object type D1c is determined to be one of the five types, as in the embodiment of FIG. 8. It is assumed that the correspondence between the objects 810 to 870 and the object type D1c is the same as the correspondence in the embodiment of FIG. 8.

FIG. 11 is a schematic diagram showing an example of a classification model. In this embodiment, a classification model M3 is a program module forming a convolutional neural network. Although illustration is omitted, the data of the trained classification model M3 is stored in advance in the nonvolatile memory 230 of the first data processing apparatus 200.

The classification model M3 includes p (p is an integer larger than or equal to 1) convolutional layers V31 to V3p and q (q is an integer larger than or equal to 1) fully connected layers N31 to N3q following the convolutional layers V31 to V3p (p is 2, for example, and q is 3, for example). A pooling layer is provided immediately after one or more of the p convolutional layers V31 to V3p. The classification model M3 generates output data M3o based on input image data M3i input to the classification model M3. The output data M3o indicates confidence for each of a plurality of types of object regions. The type associated with the highest confidence indicates the type of object region represented by the input image data M3i.

The convolutional layers V31 to V3p perform, on the input data, processing including a convolution process using filters and a bias addition process. Each of the convolutional layers V31 to V3p has a set of parameters including a plurality of weights of a plurality of filters and a plurality of biases. The pooling layer performs processing of reducing the number of dimensions of the data input from the immediately preceding convolutional layer. In this embodiment, the pooling layer performs max pooling. The fully connected layers N31 to N3q reduce the dimensions of the data input from the immediately preceding layer. Each of the fully connected layers N31 to N3q has a set of parameters including a plurality of weights and a plurality of biases.

The data generated by each of the convolutional layers V31 to V3p and the fully connected layers N31 to N3q are input to an activation function and transformed. In this embodiment, Softmax is used for the last layer (here, the fully connected layer N3q) and ReLU is used for the other layers.

Image data for a plurality of images representing the objects 810 to 870 are used to train the classification model M3. A processor for training (for example, the processor 210) uses the image data to perform calculations on each layer V31 to V3p, N31 to N3q of the classification model M3, thereby generating the output data M3o. Then, the processor for training adjusts a plurality of parameters of the classification model M3 such that the output data M3o become closer to the correct data. For example, image data for an image of the logotype 810 is input to the classification model M3. The first character type is associated with the logotype 810. Thus, the plurality of parameters of the classification model M3 are adjusted such that the confidence of the first character type indicated by the output data M3o is maximized. For the other objects 820 to 870, similarly, the plurality of parameters of the classification model M3 are adjusted such that the confidence of the object type D1c associated with the object is maximized.

Various methods may be used to adjust the parameters. In this embodiment, the plurality of parameters of the classification model M3 are adjusted such that the loss calculated using the loss function is small. The loss function may be various functions for calculating the evaluation value of the difference between the output data M3o and the correct data associated with the input image data M3i input to the classification model M3 (for example, cross entropy, squared sum error, and so on). As an algorithm for adjusting the plurality of parameters, for example, an algorithm using backpropagation and gradient descent may be adopted. Here, a so-called Adam's optimization may be performed. The correct data is generated in advance by the operator.

In S210b (FIG. 10), the processor 210 uses the object region image data of the target object region to perform calculations of each layer V31 to V3p, N31 to N3q of the trained classification model M3 (FIG. 11), thereby generating the output data M3o. The output data M3o indicates an appropriate object type D1c for the target object region. The processor 210 determines the object type D1c to be the type indicated by the output data M3o. The processor 210 then ends the processing of FIG. 10.

As described above, in this embodiment, in the process of generating the correspondence data D1, the processor 210 determines the type of object region (here, the object type D1c) by using the classification model M3 trained to classify the types of object regions. The processor 210 generates appropriate correspondence data D1 by using the classification results from the classification model M3.

The generation process of this embodiment is the same as the generation process of the second embodiment (FIG. 4) except that the classification model M3 is used to determine the object type D1c. Thus, this embodiment has the same various advantages as the second embodiment.

### D. FOURTH EMBODIMENT

FIG. 12 is a flowchart showing another embodiment of the generation process of the correspondence data D1. In this embodiment, S510 to S560 are inserted between S180 and S190 in FIG. 4. If the determination result of S180 is Yes, the processing proceeds to S510. If the determination result of S180 is No, the processing returns to S150. This embodiment may be applied to each of the first to third embodiments described above.

There are cases in which marks provided based on law or standards are shown together with other objects. For example, a “CE mark” may be shown with a “character string representing the country of manufacture.” In this case, the inspection condition equivalent to the inspection condition for the “CE mark” may be applied to the “character string representing the country of manufacture.” In this embodiment, it is assumed that the certification mark 820 (FIG. 3A) is the “CE mark”. Particular condition information (also referred to as a particular type) associated with a particular inspection condition is added to a plurality of types selectable as the object type D1c (FIG. 5). The particular inspection condition indicates the same standard as the inspection condition for the “CE mark”, and is applied to the “character string representing the country of manufacture” shown together with the “CE mark”. In this embodiment, the second character string 870 is “character string representing the country of manufacture”. In a case where the label sheet does not include the “CE mark”, the object type D1c of the “character string representing the country of manufacture” is the same as the object type D1c in each of the above embodiments (for example, the character type in FIG. 6 or the first character type in FIG. 8).

In S510 (FIG. 12), the processor 210 searches for an object region representing the “CE mark” from the plurality of object regions detected in S130 (FIG. 4). The search method may be any method. For example, pattern matching using preliminarily prepared “CE mark” image data may be adopted. Hereinafter, the object searched for in S510 will also be referred to as a first object. The “CE mark” is an example of the first object.

In S520, the processor 210 determines whether a first object region representing the first object is found. If the first object region is not found (S520: No), the processor 210 proceeds to S190 (FIG. 4).

If the first object region is found (S520: Yes), in S530 the processor 210 searches for the object region representing the “character string representing the country of manufacture (the second character string 870 in this embodiment)” from the plurality of object regions. The search method may be any method. For example, pattern matching using preliminarily prepared image data of the character string “MADE IN” may be adopted. Hereinafter, the object searched for in S530 will also be referred to as a second object. The “character string representing country of manufacture” is an example of the second object.

In S540, the processor 210 determines whether a second object region representing a second object is found. If the second object region is not found (S540: No), the processor 210 proceeds to S190 (FIG. 4).

If the second object region is found (S540: Yes), in S550 the processor 210 determines that the type of the second object region is the particular type. In S560, the processor 210 changes the data indicating the object type D1c of the second object region in the correspondence data D1 (FIG. 5) to data indicating the particular type. The processor 210 then proceeds to S190 (FIG. 4). In this way, in a case where the label sheet includes the “CE mark”, the object type D1c of “character string representing country of manufacture” is set to the particular type. Although illustration is omitted, in the inspection process, the processor 310 of the second data processing apparatus 300 sets the criterion of the inspection condition of the “character string representing the country of manufacture” to a criterion associated with the particular type (in this embodiment, the same as the criterion of the inspection condition for “CE mark”).

As described above, in the generation process of this embodiment, the processor 210 executes the following processing. In S510 (FIG. 12), the processor 210 searches the K object regions contained in the label sheet for a first object region representing a predetermined first object (the certification mark 820 in this embodiment). If the first object region is found (S520: Yes), in S530 the processor 210 searches the K object regions for a second object region representing a predetermined second object (the second character string 870 in this embodiment). If the second object region is found (S540: Yes), in S550 to S560, the processor 210 sets the condition information D1c associated with the object region information D1b (FIG. 5) specifying the second object region to the particular condition information associated with the predetermined particular inspection condition. According to this configuration, in a case where the label sheet includes the first object and the second object, the processor 210 generates the correspondence data D1 in which the second object region is associated with the particular inspection condition. In this way, the processor 210 flexibly determines the correspondence between the object regions and the condition information D1c depending on the plurality of objects included in the label sheet.

### E. FIFTH EMBODIMENT

FIG. 13 is a schematic diagram showing another example of a label sheet. On a label sheet 800e, the objects 820, 830, 850 and 870 of the label sheet 800 of FIG. 3A are replaced with objects 820e, 830e, 850e and 870e. The certification mark 820e is a mark different from the certification mark 820 in FIG. 3A. The description 830e describes information different from the information of the description 830 in FIG. 3A. The first character string 850e represents a model number different from the model number of the first character string 850 in FIG. 3A. The second character string 870e represents a country of manufacture different from the country of manufacture of the second character string 870 in FIG. 3A. The photograph 860 is omitted. The position of the description 830e within the label sheet 800e is different from the position of the description 830 within the label sheet 800 (FIG. 3A). Hereinafter, the label sheet 800 in FIG. 3A will be referred to as a first type label sheet 800, and the label sheet 800e in FIG. 13 will be referred to as a second type label sheet 800e. The correspondence data D1 for the first type label sheet 800 will be referred to as first correspondence data D1.

A plurality of different label sheets 800 and 800e may be inspected. In this case, the first data processing apparatus 200 (FIG. 1) generates second correspondence data for the second type label sheet 800e in addition to the first correspondence data D1 for the first type label sheet 800. Like the first correspondence data D1 (FIG. 5), the second correspondence data indicates the correspondence among the object number D1a, the object region information D1b, and the condition information D1c.

FIG. 14 is a flowchart showing an example of a generation process. In S610, the processor 210 generates the first correspondence data D1 for the first type label sheet 800. The generation process of S610 may be the same as the generation process of an embodiment arbitrarily selected from the above plurality of embodiments. In S620, the processor 210 generates the second correspondence data for the second type label sheet 800e. The algorithm of the generation process of S620 may be the same as the algorithm of the generation process of S610. The object detection model M1 (FIG. 1) is trained in advance to detect objects 810, 820e, 830e, 840, 850e, and 870 included in the second type label sheet 800e in addition to the objects 810 to 870 included in the first type label sheet 800. In S620, the processor 210 generates the second correspondence data by using the captured image data of the second type label sheet 800e.

As described above, the processor 210 executes the processing of generating the second correspondence data for the second type label sheet 800e in addition to the processing of generating the first correspondence data D1. The processing of generating the second correspondence data includes the processing of FIG. 4. In S130, the processor 210 uses a trained object detection model to detect T object regions corresponding to T objects 810, 820e, 830e, 840, 850e, 870 from the captured image data representing the captured image of the second type label sheet 800e containing T (in this embodiment, T-6) objects and having no abnormality in visual. In S135 to S180, the processor 210 generates the second correspondence data indicating T correspondences respectively corresponding to the T object regions. Each of the T correspondences indicates the correspondence between the object region information D1b and the object type D1c, like the correspondences in FIG. 5. The object region information D1b (specifically, the coordinates D1b1 and D1b2) is an example of information that specifies the object region in the captured image of the second type label sheet 800e. Further, similarly to the object type D1c of the first correspondence data D1, the object type D1c of the second correspondence data indicates the inspection condition associated with the type of object region among U inspection conditions (U is an integer larger than or equal to 1 and smaller than or equal to T; for example, U=L). Thus, the object type D1c is an example of condition information indicating inspection condition. Then, in S190 of FIG. 4, the processor 210 stores the second correspondence data in the memory 215.

According to this configuration, the second correspondence data referred to for determining the inspection condition (here, the reference value Vx) of the object region when inspecting the second type label sheet 800e is generated appropriately. If the operator determines information indicating the coordinates and type of each object region and inputs the determined information into the first data processing apparatus 200, the burden on the operator is heavy. In particular, in a case where each of the plurality of label sheets 800 and 800e contains a plurality of objects as in the embodiments of FIGS. 3A and 13, it is not easy for the operator to determine the correct correspondence of each of the plurality of objects. In this embodiment, the processor 210 generates a plurality of appropriate correspondence data for the label sheets 800 and 800e without the operator determining the coordinates and types of the object regions. Thus, the burden on the operator is greatly reduced.

### F. MODIFICATIONS

(1) The process of determining the type of object region based on a predetermined rule may be various other processes instead of the process of FIG. 6. For example, the processor 210 may calculate the variance of the component values for each color component. The processor 210 may then determine whether a second condition is satisfied that all variances of all color components are larger than or equal to a variance threshold. The processor 210 may proceed to S260 if the second condition is satisfied and proceed to S250 if the second condition is not satisfied. The processor 210 may also determine the type of object region from a larger number of types, such as the embodiment of FIG. 8, by analyzing the image in more detail.

(2) Instead of the configuration of FIG. 11, the configuration of the classification model for classifying the types of object regions may be various other configurations for indicating the correspondence between image data and types. For example, a classification model may consist of a plurality of fully connected layers.

(3) In the embodiment of FIG. 12, the first object region searched for in S510 and the second object region searched for in S530 may be a region representing any other object, instead of the “CE mark” and the “character string representing the country of manufacture”. For example, the first object region may be the “GS mark” and the second object region may be the “description explaining precautions based on laws and regulations”. In either case, the inspection condition associated with the second object region may be any condition. For example, a defect tolerated by the inspection condition associated with the second object region may be smaller than a defect tolerated by the inspection condition associated with the first object region.

(4) The object region information D1b of the correspondence data D1 (FIG. 5) may be any information specifying the object region in the captured image, instead of the coordinates D1b1 and D1b2. For example, the object region information D1b may indicate the coordinates of the center of the object region, the length of the object region in the first direction Dx, and the length of the object region in the second direction Dy. As the object region information D1b, it is possible to employ various types of information that specify the part included in the object region and the part not included in the object region in the captured image.

The condition information D1c may be any information indicating an inspection condition instead of the identification number of the type of object region. For example, the condition information D1c may indicate the reference value Vx. It can be said that the identification number of the type of object region indicates the identification number of the inspection condition.

(5) The inspection process may be various processes for inspecting an inspection target including a plurality of objects (for example, the label sheets 800, 800e), instead of the processes in FIGS. 7 and 9. For example, the calculation formula for the difference Vd may be various calculation formulas for calculating the evaluation value of the difference between the target object image and the reference image corresponding to the target object region. For example, when comparing the color value of each pixel between the two images, the difference Vd may be the total number of different color pixels, which are pixels indicating a color value difference larger than or equal to a predetermined reference value. The color value difference may be various values that increase as a visual color difference increases. For example, the color value difference may be the sum of the three absolute values of the three RGB differences. The difference Vd may be the ratio of different color pixels to all pixels of the image. The difference Vd may be various values indicating the magnitude of the visual difference between the target object image and the reference image.

(6) The total number L of inspection conditions applied to the first type label sheet 800 may be any integer larger than or equal to one and smaller than or equal to K (K is the total number of objects included in the first type label sheet 800). In a case where L is two or more, a plurality of inspection conditions are used for inspection, so appropriate inspection of the first type label sheet 800 is performed. The total number of objects K may be any integer larger than or equal to one. In a case where K is two or more, the first type label sheet 800 represents various information using a plurality of objects. Similarly, the total number U of inspection conditions applied to the second type label sheet 800e may be any integer larger than or equal to 1 and smaller than or equal to T (T is the total number of objects included in the second type label sheet 800e). In a case where U is two or more, a plurality of inspection conditions are used for inspection, so appropriate inspection is performed. The total number of objects T may be any integer larger than or equal to one. In a case where Tis two or more, the second type label sheet 800e represents various information using a plurality of objects. Here, U may be different from L, and T may be different from K. In any case, the numbers K, L, T, and U are predetermined.

The L reference values corresponding to the L inspection conditions may be various values. For example, in the embodiment of FIG. 9, the two reference values Va1 and Va5 corresponding to the two inspection conditions are the smallest reference values (that is, the reference values that are most difficult to satisfy). A plurality of reference values (for example, Va2, Va4) corresponding to a plurality of inspection conditions may be the largest reference value (that is, the reference value that is easiest to satisfy). Thus, a plurality of reference values for a plurality of inspection conditions may be the same. Alternatively, the L reference values for the L inspection conditions may differ from each other. The U reference values corresponding to the U inspection conditions may be various values.

(7) Various types of object regions may be associated with inspection conditions. The types of object regions may include one or more of “first type including marks provided based on standards or laws”, “second type including photographs”, and “third type including characters”. Further, the type of object regions may include a “fourth type including one or both of illustrations and photographs”.

(8) When comparing the easiness of satisfaction among a plurality of inspection conditions, in order to mitigate the effects of differences in image size (that is, the number of pixels), for example, the difference Vd which has been normalized according to image size may be used. For example, in the above embodiment, the difference Vd is the average value of the sum of the differences of all pixels, and the effect of size on the difference Vd is mitigated. Thus, if the difference Vd is the same, the inspection result based on the first inspection condition is acceptable (pass), and the inspection result based on the second inspection condition is unacceptable (failure), the second inspection condition is more difficult to satisfy than the first inspection condition.

(9) The object detection model may be any other model instead of the YOLO model. The object detection model may be, for example, an improved YOLO model such as “YOLO v3”. Other models may also be used, such as SSD, R-CNN, Fast R-CNN, Faster R-CNN, and Mask R-CNN.

(10) The inspection target to be inspected is not limited to label sheets affixed to products (for example, multifunction peripherals, sewing machines, cutting machines, portable terminals, and so on), but may be any inspection target including one or more objects. For example, the inspection target may be a label image printed directly on a product. Also, the inspection target may be any part of a product, such as a tag attached to the product, an accessory, and so on. In either case, objects included in the inspection target are not limited to objects represented by two-dimensional images such as marks and character strings, and may include three-dimensional objects having three-dimensional shapes. Such objects may also be inspected using captured image data.

(11) The color components of the image data used for generating the correspondence data (for example, the correspondence data D1 in FIG. 5) and for inspecting the inspection target are not limited to the three color components of RGB, and may be any color component. For example, monochrome image data representing only luminance values may be used. Also, image data of four color components of CMYK may be used.

(12) The generation apparatus that executes the generation process (for example, the generation process in FIG. 4) may be an apparatus different from a personal computer (for example, the data processing apparatus 200 (FIG. 1), such as digital cameras, scanners, smartphones, and servers, for example. A plurality of apparatuses (for example, computers) that communicate with each other via a network may share the functions of the generation process and provide the functions of the generation process as a whole. In this case, a system including these apparatuses serves as the generation apparatus. The same applies to an inspection apparatus that executes the inspection process (for example, the inspection process in FIG. 7). The same apparatus may perform both the generation process and the inspection process.

In each of the above embodiments, part of the configuration implemented by hardware may be replaced with software, or conversely, part or all of the configuration implemented by software may be replaced with hardware. For example, the determination process of FIG. 6 may be implemented by a dedicated hardware circuit.

In a case where part or all of the functions of the present disclosure are realized by a computer program, the program may be provided in a form stored in a computer-readable storage medium (for example, a non-transitory storage medium). The program may be used in a state where the program is stored in the same or different storage medium (computer-readable storage medium) as when the program is provided. The “computer-readable storage medium” is not limited to portable storage media such as memory cards and CD-ROMs, but also may include internal storage devices such as various ROMs in computers and external storage devices that are connected to computers, such as hard disk drives.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided as appropriate.

What is claimed is:

1. A non-transitory computer-readable storage medium storing a set of program instructions for a computer that generates data for inspecting visual of an inspection target, the set of program instructions, when executed by a controller of the computer, causing the computer to perform:
based on first captured image data indicating a first captured image of a first inspection target, detecting K object regions corresponding to K (K is an integer larger than or equal to one) objects by using a trained object detection model, the first inspection target including the K objects and having no abnormality in visual;
generating first correspondence data indicating K correspondences corresponding to respective ones of the K object regions, each of the K correspondences indicating a correspondence between object region information and condition information, the object region information being information specifying an object region in the first captured image of the first inspection target, the condition information indicating an inspection condition associated with a type of the object region, the inspection condition being among L (L is an integer larger than or equal to one and smaller than or equal to K) inspection conditions; and
storing the first correspondence data in a memory.

2. The non-transitory computer-readable storage medium according to claim 1, wherein the generating the first correspondence data includes determining the type of the object region by analyzing an image of the object region based on a predetermined rule.

3. The non-transitory computer-readable storage medium according to claim 1, wherein the generating the first correspondence data includes determining the type of the object region by using the trained object detection model or a classification model trained to classify types of the object regions.

4. The non-transitory computer-readable storage medium according to claim 1, wherein the integer L is larger than or equal to two;
wherein each of the L inspection conditions is a condition for determining that a difference indicates that visual of an object represented by a target object image is normal, the difference being a difference between the target object image and a reference object image, the target object image being an image of a region indicated by the object region information in a captured image for inspection, the reference object image being an image of an object that is preliminary associated with the object region information and that has no abnormality; and
wherein the L inspection conditions includes a plurality of inspection conditions indicating different criteria for determining that the difference indicates that the visual is normal.

5. The non-transitory computer-readable storage medium according to claim 4, wherein the type of the object region is one of L types including a first type, the first type including a mark provided based on a standard or a law; and
wherein a criterion indicated by the inspection condition associated with the first type is a criterion that is most difficult to satisfy among L criteria indicated by the L inspection conditions associated with the L types.

6. The non-transitory computer-readable storage medium according to claim 4, wherein the type of the object region is one of L types including a second type including a photograph; and
wherein a criterion indicated by the inspection condition associated with the second type is a criterion that is easiest to satisfy among L criteria indicated by the L inspection conditions associated with the L types.

7. The non-transitory computer-readable storage medium according to claim 4, wherein the type of the object region is one of L types including a third type and a fourth type, the third type including a character, the fourth type including at least illustration or photograph; and
wherein a criterion indicated by the inspection condition associated with the third type is more difficult to satisfy than a criterion indicated by the inspection condition associated with the fourth type.

8. The non-transitory computer-readable storage medium according to claim 1, wherein the set of program instructions, when executed by the controller, causing the computer to perform:
searching the K object regions for a first object region indicating a predetermined first object;
in response to finding the first object region, searching the K object regions for a second object region indicating a predetermined second object; and
in response to finding the second object region, setting the condition information associated with the object region information specifying the second object region to particular condition information, the particular condition information being associated with a predetermined particular inspection condition.

9. The non-transitory computer-readable storage medium according to claim 1, wherein the set of program instructions, when executed by the controller, causing the computer to perform:
based on second captured image data indicating a second captured image of a second inspection target, detecting T object regions corresponding to T (T is an integer larger than or equal to one) objects by using the trained object detection model, the second inspection target including the T objects and having no abnormality in visual;
generating second correspondence data indicating T correspondences corresponding to respective ones of the T object regions, each of the T correspondences indicating a correspondence between object region information and condition information, the object region information being information specifying an object region in the second captured image of the second inspection target, the condition information indicating an inspection condition associated with a type of the object region, the inspection condition being among U (U is an integer larger than or equal to one and smaller than or equal to T) inspection conditions; and
storing the second correspondence data in the memory.

10. The non-transitory computer-readable storage medium according to claim 1, wherein the generating the first correspondence data includes determining the type of the object region by:
determining whether a peak value of each color component of the object region is smaller than a threshold;
in response to determining that the peak value is larger than or equal to the threshold, performing a character recognition process;
in response to recognizing a character by the character recognition process, determining that the object region is a character type;
in response to recognizing no character by the character recognition process, determining that the object region is a first image type; and
in response to determining that the peak value is smaller than the threshold, determining that the object region is a second image type.

11. A generation apparatus comprising:
a controller; and
a memory storing instructions, the instructions, when executed by the controller, causing the generation apparatus to perform:
based on first captured image data indicating a first captured image of a first inspection target, detecting K object regions corresponding to K (K is an integer larger than or equal to one) objects by using a trained object detection model, the first inspection target including the K objects and having no abnormality in visual;
generating first correspondence data indicating K correspondences corresponding to respective ones of the K object regions, each of the K correspondences indicating a correspondence between object region information and condition information, the object region information being information specifying an object region in the first captured image of the first inspection target, the condition information indicating an inspection condition associated with a type of the object region, the inspection condition being among L (L is an integer larger than or equal to one and smaller than or equal to K) inspection conditions; and
storing the first correspondence data in the memory.

12. The generation apparatus according to claim 11, wherein the controller is configured to determine the type of the object region by analyzing an image of the object region based on a predetermined rule.

13. The generation apparatus according to claim 11, wherein the controller is configured to determine the type of the object region by using the trained object detection model or a classification model trained to classify types of the object regions.

14. The generation apparatus according to claim 11, wherein the integer L is larger than or equal to two;
wherein each of the L inspection conditions is a condition for determining that a difference indicates that visual of an object represented by a target object image is normal, the difference being a difference between the target object image and a reference object image, the target object image being an image of a region indicated by the object region information in a captured image for inspection, the reference object image being an image of an object that is preliminary associated with the object region information and that has no abnormality; and
wherein the L inspection conditions includes a plurality of inspection conditions indicating different criteria for determining that the difference indicates that the visual is normal.

15. The generation apparatus according to claim 14, wherein the type of the object region is one of L types including a first type, the first type including a mark provided based on a standard or a law; and
wherein a criterion indicated by the inspection condition associated with the first type is a criterion that is most difficult to satisfy among L criteria indicated by the L inspection conditions associated with the L types.

16. The generation apparatus according to claim 14, wherein the type of the object region is one of L types including a second type including a photograph; and
wherein a criterion indicated by the inspection condition associated with the second type is a criterion that is easiest to satisfy among L criteria indicated by the L inspection conditions associated with the L types.

17. The generation apparatus according to claim 14, wherein the type of the object region is one of L types including a third type and a fourth type, the third type including a character, the fourth type including at least illustration or photograph; and
wherein a criterion indicated by the inspection condition associated with the third type is more difficult to satisfy than a criterion indicated by the inspection condition associated with the fourth type.

18. The generation apparatus according to claim 11, wherein the controller is configured to perform:
searching the K object regions for a first object region indicating a predetermined first object;
in response to finding the first object region, searching the K object regions for a second object region indicating a predetermined second object; and
in response to finding the second object region, setting the condition information associated with the object region information specifying the second object region to particular condition information, the particular condition information being associated with a predetermined particular inspection condition.

19. The generation apparatus according to claim 11, wherein the controller is configured to perform:
based on second captured image data indicating a second captured image of a second inspection target, detecting T object regions corresponding to T (T is an integer larger than or equal to one) objects by using the trained object detection model, the second inspection target including the T objects and having no abnormality in visual;
generating second correspondence data indicating T correspondences corresponding to respective ones of the T object regions, each of the T correspondences indicating a correspondence between object region information and condition information, the object region information being information specifying an object region in the second captured image of the second inspection target, the condition information indicating an inspection condition associated with a type of the object region, the inspection condition being among U (U is an integer larger than or equal to one and smaller than or equal to T) inspection conditions; and
storing the second correspondence data in the memory.

20. A generation method of generating data for inspecting visual of an inspection target, the generation method comprising:
based on first captured image data indicating a first captured image of a first inspection target, detecting K object regions corresponding to K (K is an integer larger than or equal to one) objects by using a trained object detection model, the first inspection target including the K objects and having no abnormality in visual;
generating first correspondence data indicating K correspondences corresponding to respective ones of the K object regions, each of the K correspondences indicating a correspondence between object region information and condition information, the object region information being information specifying an object region in the first captured image of the first inspection target, the condition information indicating an inspection condition associated with a type of the object region, the inspection condition being among L (L is an integer larger than or equal to one and smaller than or equal to K) inspection conditions; and
storing the first correspondence data in a memory.
